(19) United States
(12) Patent Application Publication
(10) Pub. No.: US 2015/0210576 A1
(43) Pub. Date: Jul. 30, 2015

(54) Partially Divided Anaerobic Treatment System

(71) Applicant: ANAERGIA INC., Burlington (CA)

(72) Inventors: Juan Carlos Josse, Mission Viejo, CA (US); Ashwani Kumar, Mississauga (CA)

(21) Appl. No.: 14/417,373

(22) PCT Filed: Jul. 16, 2013
(86) PCT No.: PCT/CA2013/050550

§ 371 Date: Jan. 26, 2015

Related U.S. Application Data
(60) Provisional application No. 61/675,887, filed on Jul. 26, 2012.

(51) Int. Cl. C02F 3/30; C02F 3/12; C02F 3/28

(52) U.S. Cl. CPC C02F 3/30; C02F 3/2806; C02F 3/1263; C02F 2301/046

(57) ABSTRACT

In a waste treatment system and process, relatively low and high solids concentration streams are treated in generally parallel anaerobic reactors. The reactors may share a common wall or gas collecting cover. The reactors may also share a common downstream aerobic treatment unit. Solids produced during downstream treatment of effluent from one or both anaerobic reactors may be returned to the high solids concentration stream. The low solids concentration stream may be treated in an attached growth anaerobic digester.

### RELATED APPLICATIONS

This application claims priority to, and the benefit under 35 USC 119, of U.S. Provisional Application No. 61/675,887 filed on Jul. 26, 2012. U.S. Provisional Application No. 61/675,887 is incorporated herein by reference.

### FIELD

This specification related to systems and methods of anaerobic digestion.

### BACKGROUND

All industrial processes produce wastewater to varying degrees of quality and quantity. In some instances, a single industrial facility will produce multiple wastewater streams with different concentrations of chemical oxygen demand (COD), total solids (TS) and nutrients. At times it is beneficial to treat these wastes in a homogeneous manor with symbiotic relationships whereas in other cases the wastewater streams are dissimilar enough to warrant separate treatment techniques. In the cases where COD is higher than 1,000 mg/L, anaerobic treatment is often more cost effective and superior to aerobic processes. Unfortunately, the effluent quality from anaerobic processes rarely meets municipal effluent requirements and routinely requires further aerobic polishing.

### INTRODUCTION TO THE INVENTION

In a waste treatment system and process, two waste streams with considerably different quality are processed through two anaerobic methods in separate reactors that may share a tank wall or cover as in, for example, a ring-in-ring design. The first reactor, for example the inside ring, processes a high COD concentration, low TS concentration liquid stream using an anaerobic biofilm reactor (alternatively called a fixed film reactor, an attached film reactor or an attached growth reactor), such as an anaerobic moving bed biofilm reactor (AnMBBR), while the second reactor, for example the outer ring, treats a solid or liquid stream with higher TS concentration using a suspended growth anaerobic digester (AD). Optionally, biogas produced in both of the attached growth reactor and the AD are captured within a common digester lid which encompasses both reactors, for example the inner and outer ring. Other configurations are possible, for example two rectangular tanks sharing a common wall and a common gas holding lid. Optionally, a single waste stream can be separated to produce the two feed water streams.

In a waste treatment system and process, effluent from an anaerobic treatment unit is treated with an aerobic biological treatment, such as a sequencing batch reactor or conventional activated sludge or other, followed by or incorporating a solid-liquid separation step. A liquid portion of the aerobic biological treatment effluent may be viable for reuse or disposal, optionally after further treatment. Some or all of the solids portion of the aerobic biological treatment effluent is returned to anaerobic digestion. Optionally, the solids portion of the aerobic biological treatment effluent may be treated in a solid-liquid separation unit, such as a rotary drum thickener (RDT), with the solids portion returned to anaerobic treatment and the liquid portion returned to aerobic treatment. Optionally, the aerobic biological treatment may treat the effluent from a fixed film anaerobic reactor and AD in the system and process described in the paragraph above.

In a waste treatment system and process, two waste streams, or two portions of a wastewater stream, are treated anaerobically in separate reactors, followed by a shared downstream aerobic treatment step. Optionally, solids removed from a first waste stream or from effluent from aerobic treatment may be returned to the second waste stream. The first waste stream may be treated in a biofilm anaerobic reactor, for example an anaerobic moving bed biofilm reactor. The second waste stream may be treated in a suspended growth anaerobic digester. Effluent from the suspended growth anaerobic digester preferably passes through a solid-liquid separation step with only the liquid portion flowing to the aerobic treatment step. The solid portion may be sent for land application, disposal or further treatment.

Without intending to be limited by theory, the systems and processes described above are believed to be effective because a significant portion of the waste is treated in anaerobic or aerobic processes, or both, intended to preferentially treat soluble contaminants such as COD. This allows nearly single pass anaerobic or aerobic treatments, with low hydraulic retention times (for example 6 hours or less) to be used for a significant portion of the waste. Particulate contaminates may be separated, preferably concentrated, and sent to a suspended growth anaerobic digester to provide the longer hydraulic retention time need to digest solids. The activity in the AD is enhanced by the higher solids content provided by keeping dilute liquid streams in the system out of the AD.

### BRIEF DESCRIPTION OF THE FIGURES

FIG. 1 is a process flow diagram for a wastewater treatment process.

### DETAILED DESCRIPTION

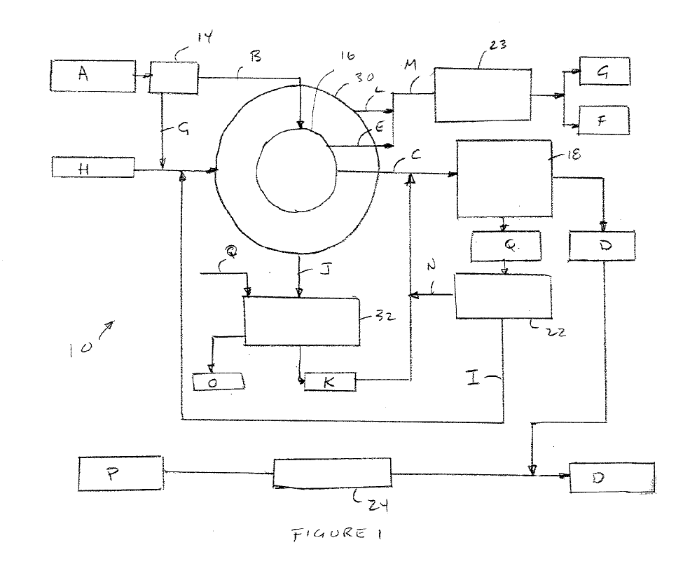

FIG. 1 shows a system 10 for treating waste. System 10 is intended to receive more than one waste stream, or a wastewater stream that has been divided, including a relatively high TS concentration stream and a relatively low TS concentration stream. The low TS concentration stream may have a high COD concentration. The high TS concentration stream may be a solids stream. A solids stream includes some water and might be fed to the system 10 as is or in a mixture with further dilution water. Examples of solids streams include waste from industrial food preparation (for example food or vegetable processing) facilities, agricultural or forestry waste or by-products, sludge (including dewatered sludge, dried sludge and biosolids) from industrial or municipal wastewater treatment plants, and green waste such as municipally collected yard waste.

The high TS concentration steam is treated in a suspended growth anaerobic digester. The low TS concentration stream is treated in an anaerobic moving bed bioreactor (AnMBBR) or an alternative attached growth reactor. Optionally, at least some particulate COD and suspended solids may be removed from the low TS concentration stream and added to the high TS concentration stream before anaerobic treatment. Influent waste, initially high in COD, is thereby treated in one of two generally parallel anaerobic reactors and produces biogas.

Effluent from anaerobic digestion may be subsequently treated aerobically if required to meet discharge regulations or re-use specifications. Solids removed from aerobic treatment may be returned to the high TS concentration stream. Optionally, the parallel anaerobic reactors may share a common downstream aerobic treatment unit.

Optionally, the parallel anaerobic reactors may share one or more of a common tank wall and cover. For example, a circular reactor may be located within an outer ring-shaped reactor or two rectangular rectors may be have a common wall. A single gas collecting cover may span both tanks.

In the system 10 shown, influent A is a wastewater stream containing soluble COD among other contaminants. Influent H is a solid or liquid waste stream high in TS, for example from food processing or agricultural operations. Influent A and influent H may be two separate streams created by one or more than one facility. Alternatively, influent H may be a solids portion separated from influent A. Optionally, and particularly when influent A and influent H are separately created waste streams, influent A may pass through a solid-liquid separation step 14, such as a primary screen, to divert solids in screenings G from influent A to influent H.

Influent A, or screened influent B, passes through a primary treatment path having steps of attached growth anaerobic treatment in anaerobic MBBR 16 and aerobic treatment in aerobic sequencing batch reactor 18. Intermediate effluents C is produced between these steps.

Influent H passes through a primary treatment path having steps of suspended growth anaerobic treatment in digester 30, solid-liquid separation in centrifuge 32 and aerobic treatment in aerobic sequencing batch reactor 18. Intermediate effluents or liquid portions J, K are produced between these steps.

The aerobic sequencing batch reactor 18 produces a final effluent D which may be discharged, optionally after disinfection for example by chlorination or UV light. Alternatively, final effluent D may be sent to a post-treatment unit 24 to be further processed as required to produce re-use water P.

Biogas E is produced from anaerobic MBBR 16 and biogas L is produced from digester 30. Although these are shown as separate streams, a common cover may span both reactors such that only one combined biogas stream M is produced. Biogas M may be used as a fuel, for example in combined heat and power unit 23 which produces electricity G and heat F.

Aerobic SBR 18 also produces an aerobic sludge Q. Aerobic sludge Q is sent to a solid-liquid separation step such as rotary drum thickener 22. Rotary drum thickener 22 produces a liquid portion or filtrate N that may be optionally treated aerobically in the aerobic SBR 18. A solids portion I from the rotary drum thickener 22 is sent to the digester 30.

Anaerobic sludge J from the digester 30 is sent to a solid-liquid separation device such as centrifuge 32 optionally with additional polymer Q. A liquid portion or centrate K produced by the centrifuge 32 may is sent to the aerobic SBR 18. A solids portion or cake O produced by the centrifuge 32 may be disposed in landfill, land applied or further treated.

In the description above, the terms solids portion and liquid portion indicate the higher solids content and lower solids content, respectively, of two streams produced from a solid-liquid separation device. The solids portion still contains some liquid, and the liquid portion may still contain some solids. Depending on the particular solid-liquid separation device used, the solids portion might be called screenings, cake, retentate, reject, thickened solids, sludge, bottoms or by other terms. The liquid portion might be called effluent, permeate, filtrate, centrate or by other terms.

The suspended growth anaerobic digester may be a mixed tank digester with hydraulic mixers intended for high solids operation as produced, for example, by UTS Biogas. The anaerobic MBBR 16 may be replaced with another attached or fixed film reactor or by a UASB or other granular reactor. The aerobic SBR 18 may be replaced with another aerobic treatment unit and may include anoxic or other zones so as to enable biological or chemical removal or nitrogen or phosphorous.

The system 10 may be used, for example, with an industrial (i. e. food processing) or agricultural operation that produces both a solid waste stream, or high solids concentration liquid waste stream, and a wastewater stream or with multiple closely located industrial or agricultural operations. The system 10 may also be used to co-digest industrial or agricultural solid waste or high solids concentration liquid waste with municipal wastewater. The system 10 may also be used to treat a single waste stream that can be separated into high solids and low solids portions.

1. A waste treatment system comprising two anaerobic treatment tanks sharing a common tank wall or cover wherein each of the tanks are used to conduct a different anaerobic treatment process.

2. The system of claim 1 having an aerobic treatment unit connected to receive at least part of effluents from both of the anaerobic treatment tanks.

3. The system of claim 2 wherein the aerobic treatment unit is a sequencing batch reactor.

4. The system of claim 2 further comprising a solid-liquid separation device connected to a sludge outlet of the aerobic treatment unit and a conduit for returning a solids portion of the sludge to one of the anaerobic treatment tanks.

5. The system of claim 2 having a solid liquid separation device between at least one of the anaerobic treatment tanks and the aerobic treatment unit.

6. The system of claim 1 wherein one of the anaerobic treatment tanks contains suspended growth and the other anaerobic treatment tank contains an attached growth.

7. The system in claim 6 wherein the attached growth is supported on a moving bed.

8. The system of claim 1 wherein one of the two anaerobic treatment tanks is located inside of the other anaerobic treatment tank.

9. The system of claim 1 wherein the two anaerobic treatment tanks share a common tank wall and cover.

10. The system of claim 1 having a solid liquid separation device upstream of the two anaerobic treatment tanks.

11. A waste treatment process comprising steps of
a) anaerobic treatment of a feed stream to produce a first effluent;
b) aerobic treatment of the first effluent to produce a second effluent and sludge; and,
c) conveying at least part of the sludge to the anaerobic treatment step.

12. The process of claim 11 wherein the anaerobic treatment step comprises suspended growth anaerobic treatment and attached growth anaerobic treatment.

13. The process of claim 11 further comprising a step of removing solids from the first effluent prior to the aerobic treatment step.

14. The process of claim 11 wherein the aerobic treatment is conducted in a sequencing batch reactor.

15. The process of claim 11 further comprising a step of treating the sludge in a solid-liquid separation unit wherein a solids portion of the sludge is conveyed to the anaerobic treatment step.

16. The process of claim 15 wherein a liquid portion of the sludge is returned to the aerobic treatment step.

17. A process comprising steps of,
a) treating a first waste stream in an attached growth anaerobic reactor to produce a first effluent; and,
b) treating a second waste stream in a suspended growth anaerobic reactor to produce a second effluent.

18. The process of claim 17 wherein a) the first waste stream and the second waste stream are produced from a common source, delivered to a common site, or separated from a common waste stream or b) at least part of the first effluent and at least part of the second effluent in a common aerobic reactor.

19. The process of claim 18 further comprising treating the at least part of the first effluent and at least part of the second effluent in a common aerobic reactor.

20. The process of claim 18 wherein the first waste stream and the second waste stream are produced from a common source, delivered to a common site, or separated from a common waste stream.

21. (canceled)

22. (canceled)

23. (canceled)

24. (canceled)

25. (canceled)

26. (canceled)

27. (canceled)
